(19) United States
(12) Patent Application Publication
(10) Pub. No.: US 2007/0146058 A1
(43) Pub. Date: Jun. 28, 2007

(54) Distribution of electrical reference

(76) Inventor: Philips Matthew Jones, Cambridge (GB)

Correspondence Address: FISH & RICHARDSON PC, P.O. BOX 1022, MINNEAPOLIS, MN, 55440-1022, US

(21) Appl. No.: 11/301,170

(22) Filed: Dec. 12, 2005

(51) Int. Cl. G05F 1/10

(52) U.S. Cl. 327/538

(57) ABSTRACT

A method for providing an electrical reference in a circuit includes determining reference control information at a master reference circuit, distributing the reference control information to one or more controlled reference circuits, and, from at least some of the controlled reference circuits, generating one or more electrical references according to the reference control information received at the controlled reference circuit.

### BACKGROUND

This invention relates to distribution of electrical references in a circuit

In circuits, such as in integrated circuits, voltage or current references may be required at multiple points in the circuit. One approach to distributing such an electrical reference is to use a single reference circuit from which the electrical reference is distributed to the points in the circuit at which the reference is required. The distribution path may be crafted to conduct the electrical reference well, for example to limit the degradation of the reference due to interfering signals and loading. Nevertheless, the distribution path is exposed to variable conditions such as dissipated heat and high frequency electromagnetic radiation (e.g., resulting from high frequency clocking of digital circuits), or cross-talk between analog signals. The variable conditions may lead to degraded distribution of the electrical reference. For many applications, it is important that the electrical reference is reliably and accurately distributed to multiple locations in the circuit.

### SUMMARY

In one aspect, in general, the invention features a method for providing an electrical reference in a circuit. The method includes determining reference control information at a master reference circuit, distributing the reference control information to one or more controlled reference circuits, and, from at least some of the controlled reference circuits, generating one or more electrical references according to the reference control information received at the controlled reference circuit.

Aspects of the invention may include one or more of the following features.

The one or more electrical references include at least one of a voltage reference or a current reference.

Distributing the reference control information includes distributing the reference control information as a digital signal.

Distributing the reference control information as a digital signal includes distributing said information as a serialized digital signal.

The method further includes storing information determined from the distributed reference control information at each of the controlled reference circuits.

The method further includes discontinuing distribution of the reference control information after storing the information determined from the distributed reference control information at each of the controlled reference circuits.

Distributing the reference control information includes repeatedly distributing the reference control information.

The reference control information is determined using a precision reference element.

Determining the reference control information includes providing a master reference value from the precision reference element.

The master reference value is compared with an actual reference value.

The actual reference value is generated form a master controlled reference circuit included in the master reference circuit, according to the reference control information.

The result of the comparison between the desired reference value and the actual reference value is encoded to produce the reference control information.

The reference control information is part of a feedback loop, said feedback loop adjusting the reference control information so that the actual reference value matches the desired reference value.

An electrical reference value generated at a first controlled reference circuit is different from an electrical reference value generated at a second controlled reference circuit.

The different electrical reference values are generated according to different reference control information received at the first and second controlled reference circuits.

The master reference circuit determines the respective reference control information according to a desired relationship between the respective electrical reference value and a master reference value from a precision reference element.

The different reference control information is distributed to the first and second controlled reference circuits serially over the same control paths.

In another aspect, in general, the invention features system. The system includes a master reference circuit including a precision reference element, said precision reference element providing a master reference value, at least one controlled reference circuit, and a control path linking the master reference circuit to at least one controlled reference circuit for distributing reference control information indicative of the master reference value.

The master reference circuit includes a master controlled reference circuit, said master controlled reference circuit providing an actual reference value.

The master controlled reference circuit provides the actual reference value based on the reference control information.

The master reference circuit is configured to generate the reference control information for distribution over the control path based on a comparison between the actual reference value master reference value.

At least one controlled reference circuit is coupled to the control path over a digital input interface.

The master reference circuit is coupled to the control path over a digital interface.

The master reference circuit includes a comparator for comparing the master reference value and the actual reference value.

The master reference includes an encoder coupled to the output of the comparator, said encoder having a digital output providing the reference control information for distribution over the control path.

The control path includes a switching element, said switching element configured to connect the control path to a ground voltage.

At least some of the controlled reference circuits, are configured to generate one or more electrical references according to the reference control information received at the controlled reference circuit.

Aspects of the invention may include one or more of the following advantages.

Reference control information that is distributed in a digital form is significantly less affected by electromagnetic radiation, heat or other perturbation and thus the controlled references receive each the same reference control information. This provides a good control of the electrical references within the system, making the system behavior robust to external undesired perturbations.

The fact that the control path may be grounded while not used to distribute reference control information may protect the controlled reference circuitry from electromagnetic noise.

Embodiments that may require multiple master reference arrangements may result in physically large objects; in comparison, with embodiments that contain just one master reference, a control path and controlled references, that are not as complex as the master reference, the size is decreased.

Another aspect that may contribute to decreasing the physical size of embodiments is that control paths that distribute control information can, in some cases, be less space consuming than paths that distribute the references themselves (e.g., by using control paths that are also being used in the system for other purposes).

By controlling the master reference operation, in particular the encoder, one may modify the desired value of an electrical reference in a single control point in a very flexible way.

Other features and advantages of the invention are apparent from the following description, and from the claims.

### DESCRIPTION OF DRAWINGS

FIG. 1 is a block diagram of an electronic system such as an integrated circuit provided with a reference distribution mechanism.

FIG. 2 is a flowchart of a reference distribution process.

FIG. 3 is a block diagram of a controlled reference circuit.

### DESCRIPTION

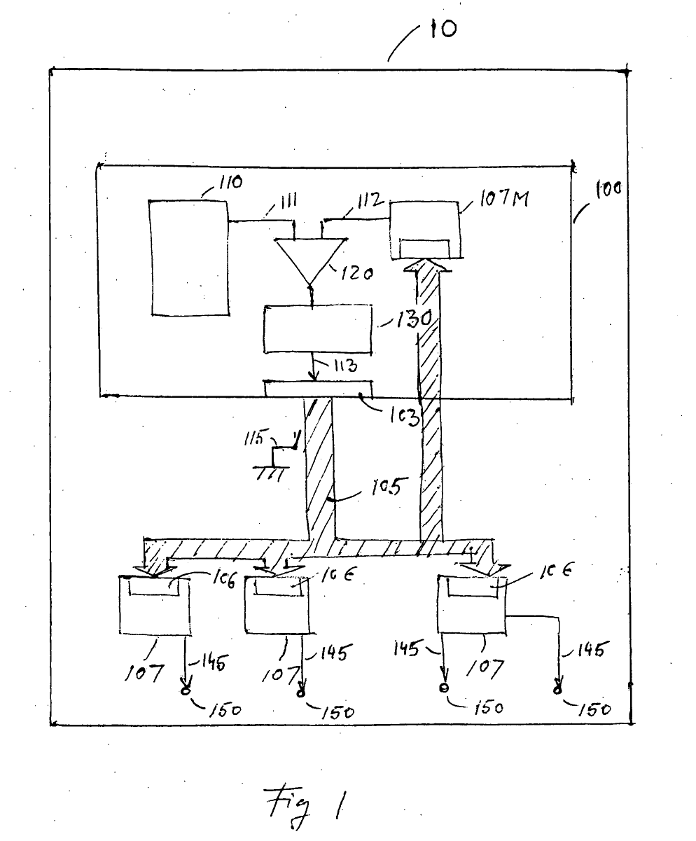

Referring to FIG. 1, an integrated circuit 10 includes circuitry for providing electrical references, such as voltage and current references, to multiple points 150 in the circuit where such references are required. The integrated circuit 10 may have analog and digital parts that may operate at radio frequency. This circuitry includes a master reference circuit 100 and a number of controlled reference circuits 107, each associated with one or more of the points 150 at which an electrical reference is required. The master reference circuit 100 generates and distributes reference control information 113 to the controlled reference circuits 107 for determining the precise value of the electrical reference 145 produced by each of the controlled reference circuits 107.

The reference control information 113 is distributed to the controlled reference circuits 107 in digital form (e.g., as binary numbers). The master reference circuit 100 includes a digital interface 103 which is coupled to a control path 105. The master reference circuit provides the reference control information 113 for the controlled references 107 over the digital interface 103 to the control path 105. Each controlled reference circuit includes a digital interface 106 over which it receives the reference control information 113.

The role of the master reference circuit 100 is to determine the reference control information 113, which is applied to the controlled reference circuits 107 so that they provide a desired electrical reference value 145, based on a corresponding electrical reference available at the master reference circuit 100. Generally, the master reference circuit 100 includes circuitry for generating a relatively more accurate electrical reference as compared to the electrical reference that can be generated by the controlled reference circuits 107 without externally provided reference control information 113. For example, the controlled reference circuits 107 may use less circuit area and/or less power, and as result may not provide as accurate an electrical reference over a range of operating conditions (e.g., temperature variations) or over a range of fabrication variations as the master reference circuit 100.

Each of the controlled reference circuits 107 are designed to provide a consistent electrical reference from one controlled reference circuit 107 to another. That is, even though the controlled reference circuits may be more susceptible to temperature or fabrication variation, they are designed such that the effects of these factors are consistent. In some implementations, each of the controlled reference circuits 107 use the same circuit layout (cell) and each of these circuits are fabricated at the same time on the same silicon wafer. Also, the controlled reference circuits 107 are expected to have the same thermal environment in operation because they are on a relatively small integrated circuit 10.

The master reference circuit 100 contains a precision reference 110, which provides a precise, master reference value 111. As discussed above, the master reference circuit 100 includes provisions for making it relatively more robust to temperature and fabrication variations as compared to the controlled reference circuits 107.

The master reference circuit 100 also contains a master controlled reference circuit 107M. This master controlled reference circuit 107M has the same properties as the controlled reference circuits 107, which are distributed in the circuit where the electrical reference is required. The master controlled reference circuit 107M provides an actual reference value 112. To the extent that the master controlled reference circuit 107M receives the same reference control information 113 as the other controlled reference circuits 107 (e.g., from the control path 105), it is expected that the reference value 112 will match the reference values 145 from each of the controlled reference circuits 107.

The master reference value 111 from the precision reference 110 and the actual reference value 112 from the master controlled reference circuit 107M are inputs to a comparator 120. The output of the comparator 120 is arranged in a feedback loop such that the reference control information 113 that is fed to the master controlled reference circuit 107M causes the actual reference value 112 to match the master reference value 111. This same reference control information 113 is passed to each of the controlled reference circuits 107 which results in the reference values 145 also matching the master reference value 111.

The comparator 120 provides at its output an indication of the sign of the difference between the desired master reference value 111 and the actual reference value 112. An encoder 130 adjusts the reference control information 113 to match the master 111 and actual 112 values. For example, in an implementation in which the reference control information 113 is a digital control value, the encoder 130 includes a successive-approximation controller to match the values. The sign indication produced by the comparator 120 is used by the successive-approximation controller to test each bit of the digital control value in turn. The controller starts with the most significant bit (MSB), sets the bit to 1, checks the sign using the comparator output, and leaves the bit at 1 if the sign is negative or sets the bit to 0 if the sign is positive. This procedure matches the values with an error no more than an amount represented by the least significant bit (LSB) of the digital control value.

The reference control information 113 is buffered at the digital interface 103 and is distributed over the control path 105 to all controlled reference circuits 107 at their respective digital interfaces 106. The control path 105 originates at the master reference digital interface 103 and leads to the controlled reference circuit digital interfaces 106 in a tree configuration. In some implementations, the control path 105 includes a single continuous conductor and the interfaces 103 and 106 provide for serial digital transmission of reference control information 113 from the master reference circuit 100 to each of the controlled reference circuits 107. Alternatively, the control path 105 can include multiple isolated conductors for parallel digital transmission of the control information 113.

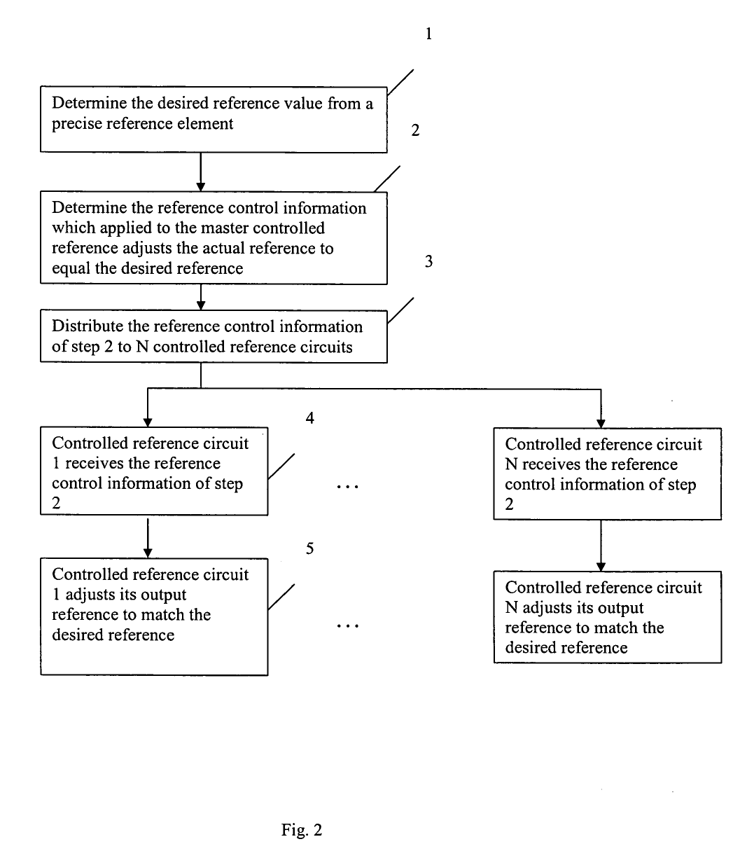

Referring to FIG. 2, in an exemplary reference distribution process, in step 1, the desired master reference value 111 is determined by sensing a precise reference element. In step 2, the reference control information 113 is determined such that when applied to the master controlled reference circuit 107M the actual reference value 112 is within a desired degree of precision of the desired master reference value 111. The reference control information 113 determined in step 2 is distributed, in step 3, to the controlled reference circuits 107. In step 4, the controlled reference circuits 107 receive the reference control information 113 determined in step 2. In step 5, the controlled reference circuits 107 adjust their respective outputs using the received reference control information 113 to deliver references close to the desired master reference value 111 determined in step 1. Other distribution processes may have different steps and/or different ordering of the steps.

The approach described above is used in an number of alternative versions of the system.

An optional feature of the approach is that the reference control information 113 is not necessary determined and distributed in a continuous manner. For example, the reference control information 113 is determined when the integrated circuit 10 is initially powered up and reaches a steady operating condition (e.g., temperature) at which time the reference control information 113 is determined at the master reference circuit 100 and distributed to the controlled reference circuits 107. This distribution of reference control information 113 can alternatively be repeated, for example, periodically, when conditions are sensed to have changed, or on command based on internal or external control logic.

In versions of the system in which the control information is not continuously transmitted over the control path 105, the integrated circuit 10 optionally includes circuitry to ground the control path 105 when it is not being used, for example, using a switch 115, such as a transistor. The grounded control path 105 increases the isolation of the different portions of the circuit through which the control path 105 passes, thereby reducing potential interference between different circuit elements, such as between digital and analog portions of the circuit.

In FIG. 1, the reference control information 113 is shown to pass to the master controlled reference circuit 107M from outside the master reference circuit 100 over the control path 105. An internal path for the reference control information 113 (e.g., from the output of the encoder 130) is alternatively used which provides logically the same effect.

In the version of the system described with reference to FIG. 1, the comparator 120 is used in a feedback arrangement. Alternatively, circuitry directly encodes the difference between the master reference value 111 and the actual reference value 112 (e.g., an absolute difference, such as millivolts, or a relative difference, such as 0.02%) which is passed to the controlled reference circuits 107 for adjustment.

The approach described above with reference to integrated circuit 10 can also be applied an electronic system such as a printed circuit board, or a shelf that contains several printed circuit boards, where the controlled references 107, 107M are spread throughout the electronic system. That is, the controlled reference circuits 107 are not necessarily all located on a single integrated circuit.

Other approaches to distributing the reference control information 113 can be used. For example, rather than serial digital encoding, the reference control information 113 is distributed over parallel digital data paths. As another example, the reference control information 113 may be distributed in an analog form in a way that is less susceptible to degradation than distributing the electrical references themselves in analog form. In this approach, the encoder 130, the interfaces 103 and 106, and circuitry within the controlled references 107, 107M are implemented using analog circuitry.

The precision reference 110 provides a reliable reference, which may be compensated for temperature variations, like increased heat and protected against electromagnetic noise. Such precision references take space within the integrated circuit 10 and consume power. In an alternative embodiment, several precision references may be placed within one or more integrated circuits, each providing reference control information 113 to different controlled reference circuits.

As another alternative, it is not required that the master reference circuit 100 necessarily send the same reference control information 113 to each of the controlled reference circuits 107. For example, different reference values 145 may be desired at different controlled reference circuits 107. The master reference circuit 100 can computationally adjust the reference control information 113 based on a desired relationship between the electrical reference value 145 and the master reference value 111. For example, the master reference circuit 100 computes reference control information that provides a desired offset (e.g., 100 microamps) between the master reference value 111 and the electrical reference value 145. In one distribution approach, the different reference control information 113 is distributed to the controlled reference circuits 107 over the same control paths 105 (e.g., serially) and each controlled reference circuit 107 selects the appropriate reference control information 113. In another distribution approach, the different reference control information 113 is distributed over separate control paths 105 to different controlled reference circuits 107.

As another alternative, the master reference circuit 100 sends the same reference control information 113 to each of the controlled reference circuits 107, and some of the controlled reference circuits 107 adjust the received reference control information 113 to produce a desired change in the electrical reference value 145.

The controlled reference circuits 107 can be used to generate one or alternatively multiple reference values. For example, each controlled reference circuit 107 can be used to generate a single reference voltage value, a single reference current value, both, multiple of each, etc.

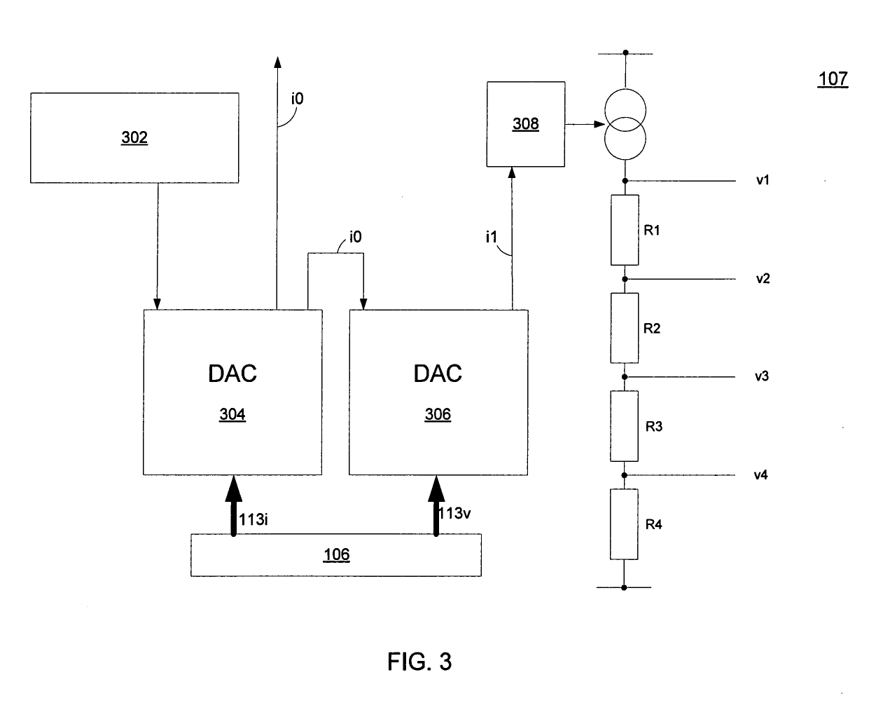

Referring to FIG. 3, an implementation of a controlled reference circuit 107 provides a current reference value i₀ and four voltage reference values v₁, v₂, v₃, and v₄. The circuit 107 controls the current reference value i₀ based on current reference control information 113i, and controls the voltage reference values v₁, v₂, v₃, and v₄ based on voltage reference control information 113v.

The current reference control information 113i and voltage reference control information 113v are determined by the master reference circuit 100 and transmitted serially to the controlled reference circuit 107 over the control path 105. The digital interface 106 receives m bits of the current reference control information 113i followed by n bits of the voltage reference control information 113v. The number of bits are selected, to provide a desired degree of precision (e.g., m=n=6 bits).

A local current source 302 provides an internal reference current that does not vary significantly within the temperature operating range of the integrated circuit 10. A first digital-to-analog converter (DAC) 304 uses the reference current provided by the current source 302 and the current reference control information 113i to set the output current reference value i₀.

The current i₀ is also provided to a second DAC 306. The DAC 306 uses the current i₀ and the voltage reference control information 113v to set a current i₁ applied to series resistors R1, R2, R3, R4 through a current mirror 308. The four output voltage reference values v₁, v₂, v₃, and v₄ are provided by terminals from each of these four resistors with respect to a ground voltage. In this implementation, since the output current i₀ is used by the DAC 306, the output voltage references depend on both the voltage reference control information 113v and the current reference control information 113i. Alternatively, the DAC 306 can use the reference current provided by the current source 302 to provide output voltage references that depend on the voltage reference control information 113v, but not on the current reference control information 113i.

It is to be understood that the foregoing description is intended to illustrate and not to limit the scope of the invention, which is defined by the scope of the appended claims. Other embodiments are within the scope of the following claims.

What is claimed is:

1. A method for providing an electrical reference in a circuit, comprising:
determining reference control information at a master reference circuit;
distributing the reference control information to one or more controlled reference circuits; and
from at least some of the controlled reference circuits, generating one or more electrical references according to the reference control information received at the controlled reference circuit.

2. The method of claim 1, wherein the one or more electrical references include at least one of a voltage reference or a current reference.

3. The method of claim 1, wherein distributing the reference control information includes distributing the reference control information as a digital signal.

4. The method of claim 3, wherein distributing the reference control information as a digital signal includes distributing said information as a serialized digital signal.

5. The method of claim 1, further comprising storing information determined from the distributed reference control information at each of the controlled reference circuits.

6. The method of claim 5, further comprising discontinuing distribution of the reference control information after storing the information determined from the distributed reference control information at each of the controlled reference circuits.

7. The method of claim 1, wherein distributing the reference control information includes repeatedly distributing the reference control information.

8. The method of claim 1, wherein the reference control information is determined using a precision reference element.

9. The method of claim 8, wherein determining the reference control information includes providing a master reference value from the precision reference element.

10. The method of claim 9, wherein the master reference value is compared with an actual reference value.

11. The method of claim 10, wherein the actual reference value is generated form a master controlled reference circuit included in the master reference circuit, according to the reference control information.

12. The method of claim 10, wherein the result of the comparison between the desired reference value and the actual reference value is encoded to produce the reference control information.

13. The method of claim 10, wherein the reference control information is part of a feedback loop, said feedback loop adjusting the reference control information so that the actual reference value matches the desired reference value.

14. The method of claim 1, wherein an electrical reference value generated at a first controlled reference circuit is different from an electrical reference value generated at a second controlled reference circuit.

15. The method of claim 14, wherein the different electrical reference values are generated according to different reference control information received at the first and second controlled reference circuits.

16. The method of claim 15, wherein the master reference circuit determines the respective reference control information according to a desired relationship between the respective electrical reference value and a master reference value from a precision reference element.

17. The method of claim 14, wherein the different reference control information is distributed to the first and second controlled reference circuits serially over the same control paths.

18. A system, comprising:
a master reference circuit comprising a precision reference element, said precision reference element providing a master reference value;
at least one controlled reference circuit; and
a control path linking the master reference circuit to at least one controlled reference circuit for distributing reference control information indicative of the master reference value.

19. The system of claim 18, wherein the master reference circuit comprises a master controlled reference circuit, said master controlled reference circuit providing an actual reference value.

20. The system of claim 19, wherein the master controlled reference circuit provides the actual reference value based on the reference control information.

21. The system of claim 19, wherein the master reference circuit is configured to generate the reference control information for distribution over the control path based on a comparison between the actual reference value master reference value.

22. The system of claim 21, wherein at least one controlled reference circuit is coupled to the control path over a digital input interface.

23. The system of claim 22, wherein the master reference circuit is coupled to the control path over a digital interface.

24. The system of claim 19, wherein the master reference circuit comprises a comparator for comparing the master reference value and the actual reference value.

25. The system of claim 24, wherein the master reference comprises an encoder coupled to the output of the comparator, said encoder having a digital output providing the reference control information for distribution over the control path.

26. The system of claim 18, wherein the control path comprises a switching element, said switching element configured to connect the control path to a ground voltage.

27. The system of claim 18, wherein at least some of the controlled reference circuits, are configured to generate one or more electrical references according to the reference control information received at the controlled reference circuit.
